(19) United States
(12) Patent Application Publication
(10) Pub. No.: US 2014/0339855 A1
(43) Pub. Date: Nov. 20, 2014

(54) PILLAR STRUCTURE FOR VEHICLE

(71) Applicant: Nobuyuki Torii, Nagoya-shi (JP)

(72) Inventor: Nobuyuki Torii, Nagoya-shi (JP)

(73) Assignee: TOYOTA JIDOSHA KABUSHIKI KAISHA, Toyota-shi, Aichi (JP)

(21) Appl. No.: 14/344,415

(22) PCT Filed: Sep. 13, 2011
(86) PCT No.: PCT/JP2011/070877

§ 371 Date: Mar. 12, 2014

(51) Int. Cl. B62D 25/04

(52) U.S. Cl. CPC B62D 25/04
USPC 296/193.06

(57) ABSTRACT

A pillar structure for a vehicle, to which a hinge of a door is attached, wherein a fragile portion is formed, respectively, above and below an attachment position of the hinge, wherein a force application member is disposed in one fragile portion of the fragile portions to transmit an external load to the fragile portions via across the one fragile portion, wherein a reinforcement member is disposed in the other fragile portion of the fragile portions to suppress deformation of the other fragile portion, and wherein the reinforcement member is in close contact with an inside of the other fragile portion.

### TECHNICAL FIELD

The present invention relates to a pillar structure for a vehicle, to which a hinge of a door is attached.

### BACKGROUND ART

PTL 1 discloses a pillar structure for a vehicle, to which a hinge of a door is attached. In the pillar structure for a vehicle disclosed in PTL 1, a fragile portion is formed, respectively, below and above the hinge, a rear end portion of a front door beam is disposed in a lower fragile portion, and a tip end portion of a rear door beam is disposed in an upper fragile portion. Accordingly, in an initial stage of a vehicle side impact collision, a load concentrates on a hinge portion. The rear end portion of the front door beam transfers impact of a local load to the lower fragile portion. The tip end portion of the rear door beam transfers impact of a local load to the upper fragile portion.

### CITATION LIST

### Patent Literature

[Patent Literature 1] Japanese Unexamined Patent Application Publication No. 2010-018254

### SUMMARY OF INVENTION

### Technical Problem

There are three pillar bending modes: a first mode in which an upper portion of the hinge bends; a second mode in which the upper portion and a lower portion of the hinge bend; and a third mode in which the lower portion of the hinge bends. It is preferred that a pillar bending mode is appropriately set to one of the modes depending on the purpose.

However, in the pillar structure for a vehicle disclosed in PTL 1, there is a possibility that depending on a load application mode, it is not possible to reliably bend a portion which is desired to bend in preference to other portions. PTL 1 discloses the fact that the lower fragile portion has strength lower than that of the upper fragile portion. However, it is difficult to reliably activate each of the modes using only the aforementioned configuration.

An object of the present invention is to provide a pillar structure for a vehicle in which it is possible to reliably bend a portion that is desired to bend in preference to other portions during a side impact collision.

### Solution to Problem

A pillar structure for a vehicle according to the present invention is the pillar structure for a vehicle, to which a hinge of a door is attached. A fragile portion is formed, respectively, above and below an attachment position of the hinge. A force application member is disposed in one fragile portion of the fragile portions to transmit an external load to the fragile portions via across the one fragile portion. A reinforcement member is disposed in the other fragile portion to suppress deformation of the other fragile portion.

According to the pillar structure for a vehicle of the present invention, when the external load is transmitted to the pillar from the force application member, deformation of the one fragile portion is promoted, deformation of the other fragile portion is suppressed and thus, it is possible to stably control the bending mode of the pillar. For this reason, when the external load is applied to the pillar, it is possible to reliably bend a fragile portion that is desired to bend in preference to other portions. Accordingly, it is possible to improve robustness against a side impact collision by optimally disposing the one and the other fragile portions.

In the present invention, it is possible to dispose the one fragile portion below the other fragile portion. Since the one and the other fragile portions are disposed in this way, it is possible to stably reduce deformation of the pillar at a height where an occupant is positioned. Accordingly, it is possible to improve robustness against a side impact collision.

In the present invention, it is possible to set the strength of the one fragile portion to a strength lower than that of the other fragile portion. Since the present invention has the configuration, when the external load is transmitted to the pillar from the force application member, it is possible to further promote deformation of the one fragile portion.

In the prevent invention, it is possible to use a door impact beam attachment member that attaches a door impact beam to the door as the force application member. Since the present invention has the configuration, it is possible to effectively release a collision impact load applied to the door of the vehicle to the pillar via the door impact beam.

In the present invention, it is possible to use a hinge reinforcement that is disposed to face the hinge with respect to the pillar as the reinforcement member. Since the present invention has this configuration, it is possible to suppress deformation of the other fragile portion without attaching a new reinforcement member.

### Advantageous Effects of Invention

According to the present invention, it is possible to reliably bend a portion that is desired to bend in preference to other portions during a side impact collision.

### BRIEF DESCRIPTION OF DRAWINGS

FIG. 1 is a side view of a center pillar structure according to an embodiment.

FIG. 2 is a front view of the center pillar structure according to the embodiment.

FIG. 3 is a partially enlarged view of the center pillar structure illustrated in FIG. 1.

FIG. 4 is a partial end surface taken along line IV-IV in FIG. 3.

FIG. 5 is a partial end surface view illustrating a state where a collision impact load is applied to a lower pillar reinforcement from a door impact beam.

FIG. 6 conceptually illustrates bending modes of a pillar reinforcement, FIG. 6(a) is a view conceptually illustrating a first mode, FIG. 6(b) is a view conceptually illustrating a second mode, and FIG. 6(c) is a view conceptually illustrating a third mode.

### DESCRIPTION OF EMBODIMENTS

Hereinafter, an embodiment of a pillar structure for a vehicle according to the present invention will be described with reference to the accompanying drawings. In the embodiment, the pillar structure for a vehicle according to the present invention is applied to a center pillar structure. In the following description, an inward and outward direction implies an inward and outward direction of the vehicle. A forward and backward direction implies a forward and backward direction of the vehicle, and an upward and downward direction implies an upward and downward direction of the vehicle. In each of the drawings, the same reference signs are assigned to the same or equivalent elements, and duplicate descriptions will be omitted.

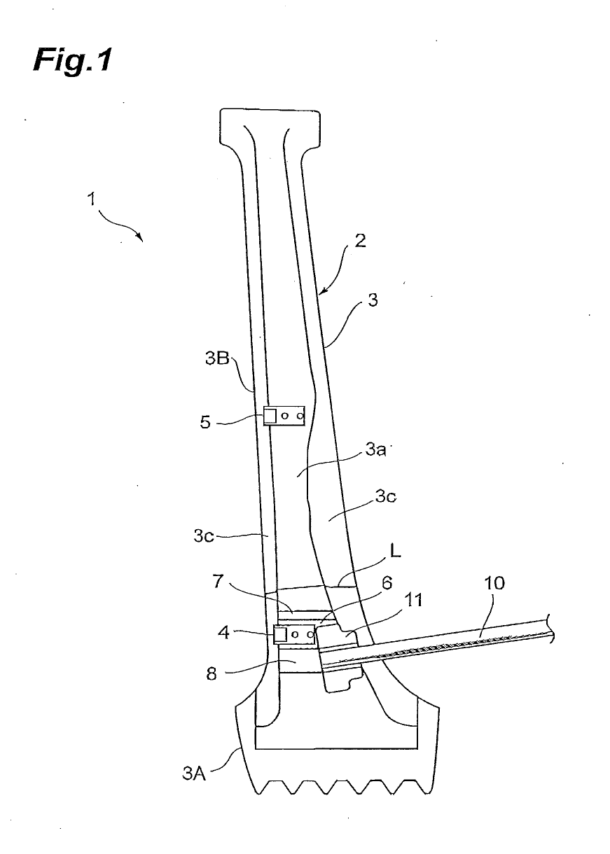

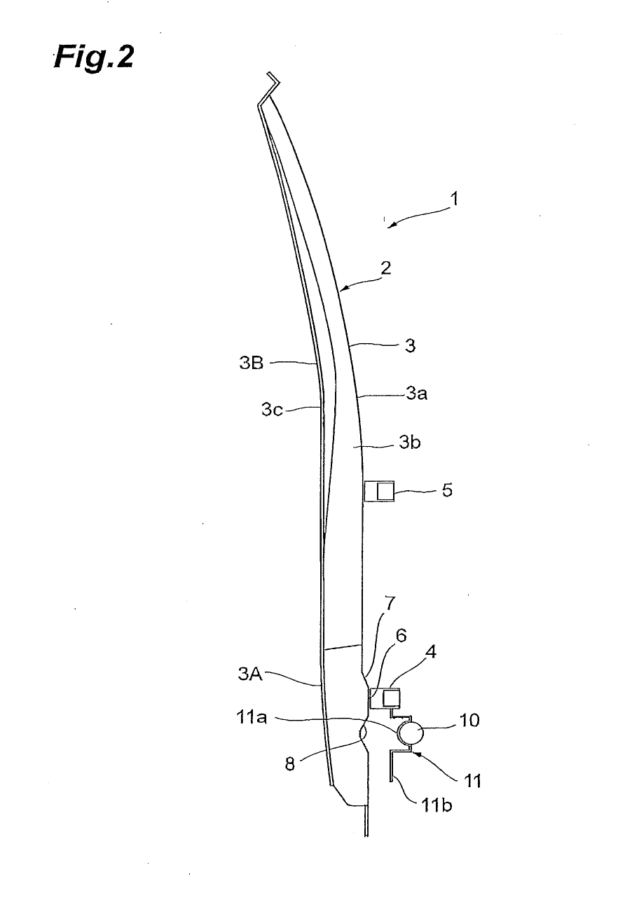

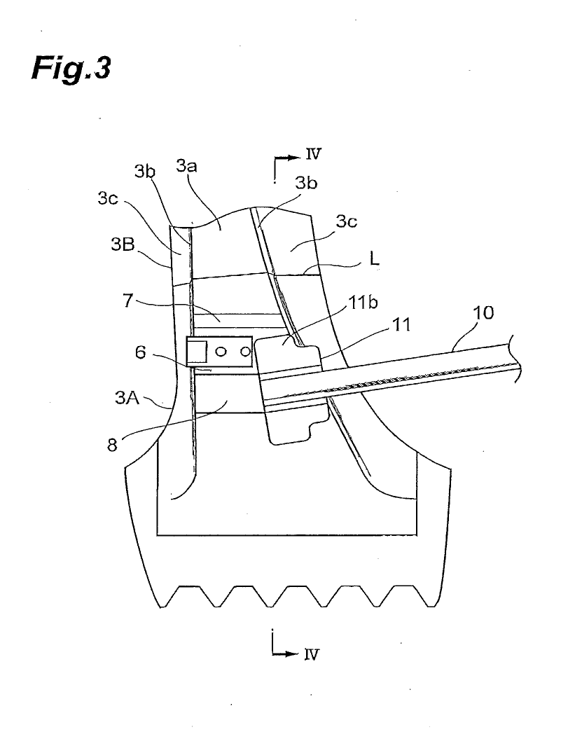

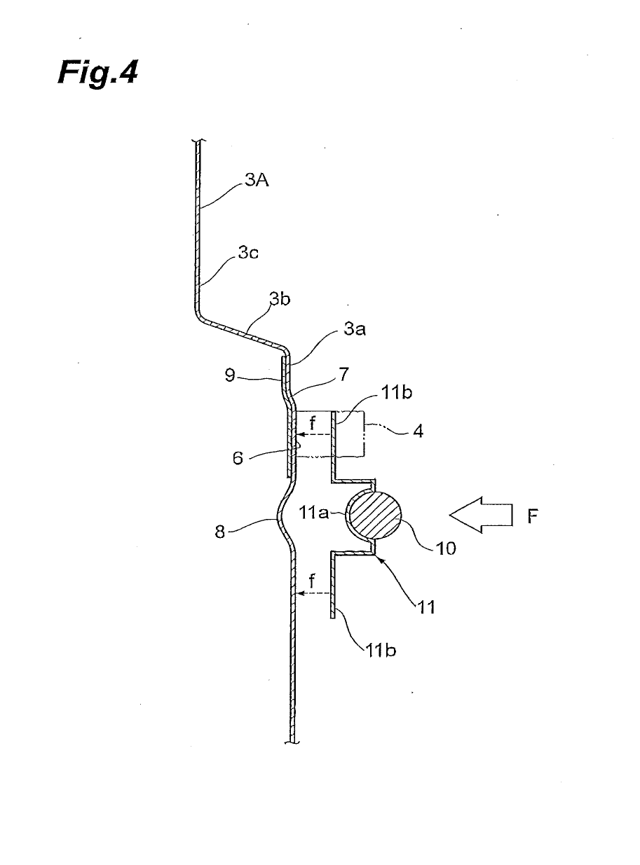

FIG. 1 is a side view of the center pillar structure according to the embodiment. FIG. 2 is a front view of the center pillar structure according to the embodiment. FIG. 3 is a partially enlarged view of the center pillar structure illustrated in FIG. 1. FIG. 4 is a partial end surface view taken along line IV-IV in FIG. 3.

As illustrated in FIGS. 1 to 4, in a center pill structure 1 according to the embodiment, a center pillar 2 is a main configuration element. The center pillar 2 is a strut that supports a rear door (not illustrated) of the vehicle. The center pillar 2 includes a pillar reinforcement 3 that extends from a rocker (not illustrated) to a roof side rail (not illustrated) in a center portion of the vehicle. As an exterior member, the center pillar 2 has an inner panel (not illustrated) attached to an inside of the pillar reinforcement 3, and an outer panel (not illustrated) attached to an outside of the pillar reinforcement 3.

The pillar reinforcement 3 is formed to have a substantially hat-shaped cross section by bending a high tension steel plate. That is, the pillar reinforcement 3 mainly includes an outer surface portion 3a that faces an outside of the vehicle, a pair of side surface portions 3b that extend toward an inside of the vehicle from both end edges of the outer surface portion 3a, and a pair of flange portions 3c that extend from an end edge of each of the side surface portions 3b in the forward and backward direction of the vehicle and in a direction in which the flange portions 3c separate from each other.

The pillar reinforcement 3 has a lower pillar reinforcement 3A and an upper pillar reinforcement 3B connected to each other via a laser welding partition line L, and the lower pillar reinforcement 3A and the upper pillar reinforcement 3B connect, respectively, to the rocker and the roof side rail. The lower pillar reinforcement 3A is disposed at a position lower than a position of an occupant's body, and the upper pillar reinforcement 3B is disposed at a position where the occupant's body is located. The lower pillar reinforcement 3A has strength lower than that of the upper pillar reinforcement 3B.

In the lower pillar reinforcement 3A, a lower hinge 4 is fixed to an outside of the outer surface portion 3a to support the rear door in an openable and closeable manner. In the upper pillar reinforcement 3B, an upper hinge 5 is fixed to the outside of the outer surface portion 3a to support the rear door in an openable and closeable manner. A portion of the lower pillar reinforcement 3A, to which the lower hinge 4 is attached, is referred to as a lower hinge attachment portion 6.

An upper fragile portion 7 and a lower fragile portion 8 are formed, respectively, above and below the lower hinge attachment portion 6 of the lower pillar reinforcement 3A.

The upper fragile portion 7 is disposed above the lower hinge attachment portion 6. The upper fragile portion 7 is a concave bead which is formed in the outer surface portion 3a of the lower pillar reinforcement 3A to extend the forward and backward direction. As long as the upper fragile portion 7 allows an upper portion of the lower hinge attachment portion 6 to have fragility, the upper fragile portion 7 may have any structure. For example, the upper fragile portion 7 may be formed by making the thickness of the lower pillar reinforcement 3A partially thin. The upper fragile portion 7 may be obtained by forming a notch or a concavity in the lower pillar reinforcement 3A or by bending the lower pillar reinforcement 3A.

The lower fragile portion 8 is disposed below the lower hinge attachment portion 6. The lower fragile portion 8 is a concave bead which is formed in the outer surface portion 3a of the lower pillar reinforcement 3A to extend the forward and backward direction of the vehicle. As long as the lower fragile portion 8 allows a lower portion of the lower hinge attachment portion 6 to have fragility, the lower fragile portion 8 may have any structure. For example, the lower fragile portion 8 may be formed by making the thickness of the lower pillar reinforcement 3A thin. The lower fragile portion 8 may be obtained by forming a notch or a concavity in the lower pillar reinforcement 3A or by bending the lower pillar reinforcement 3A.

The lower fragile portion 8 has strength lower than that of the upper fragile portion 7, and has characteristics of being likely to bend in preference to the upper fragile portion 7. For example, it is possible to realize the characteristics by forming the bead of the lower fragile portion 8 deeper than that of the upper fragile portion 7, and by making the thickness of the lower fragile portion 8 thinner than that of the upper fragile portion 7.

A hinge reinforcement 9 is attached to an inside of the lower pillar reinforcement 3A in such a manner that the hinge reinforcement 9 is disposed to face the lower hinge 4.

The hinge reinforcement 9 is a reinforcement member that reinforces the lower pillar reinforcement 3A which supports the rear door via the lower hinge 4. The hinge reinforcement 9 covers an inside of the lower hinge attachment portion 6. A lower end of the hinge reinforcement 9 is disposed at a position higher than that of the lower fragile portion 8. An upper end of the hinge reinforcement 9 is disposed at a position higher than that of the upper fragile portion 7. For this reason, the upper fragile portion 7 is reinforced with the hinge reinforcement 9, and is unlikely to bend, but the lower fragile portion 8 is not reinforced with the hinge reinforcement 9. The hinge reinforcement 9 bends along the shape of an inner surface of the lower pillar reinforcement 3A to come into close contact with the lower pillar reinforcement 3A.

In contrast, a door impact beam 10 is attached to the rear door supported by the lower hinge 4 and the upper hinge 5 which are fixed to the pillar reinforcement 3, and the door impact beam 10 reduces the amount of deformation during a side impact collision.

The door impact beam 10 is formed to have a slender columnar shape. A door impact beam attachment member 11 for connecting the door impact beam 10 to the rear door is attached to a front end portion of the door impact beam 10. The door impact beam attachment member 11 for connecting the door impact beam 10 to the rear door is attached to a rear end portion of the door impact beam 10, but since the door impact beam attachment member 11 in the rear end portion thereof is not directly affecting the center pillar structure 1, a description of the door impact beam attachment member will be omitted.

The door impact beam attachment member 11 mainly includes a retention portion 11a that retains the door impact beam 10 and has an arc-shaped cross section; and a pair of connection portions 11b that extend from both end edges of the retention portion 11a to connect to the rear door and has an L-shaped cross section. The pair of connection portions 11b extend to an inside farther than the retention portion 11a, and tip end portions of the connection portions 11b bend at substantially right angles and extend in a direction in which the tip end portions separate from each other. For this reason, the pair of connection portions 11b are disposed at an inside farther than the retention portion 11a and the door impact beam 10, and the retention portion 11a and the door impact beam 10 are floated at an outside of the pair of connection portions 11b.

In a vehicle side view, an attachment position of the door impact beam attachment member 11 with respect to the rear door is located at a position where the door impact beam attachment member 11 does not overlap with the lower hinge 4.

When another vehicle collides with a side of a host vehicle, the door impact beam 10 is pressed inward due to an impact load resulting from the side impact collision. At this time, if the door impact beam attachment member 11 is attached at a position where the door impact beam attachment member 11 overlaps with the lower hinge 4 in the vehicle side view, a collision impact load F transmitted to the door impact beam attachment member 11 from the door impact beam 10 is transmitted to the lower hinge 4 prior to being transmitted to the lower pillar reinforcement 3A. Accordingly, the collision impact load F concentrates on the lower hinge 4 and thus, it is not possible to control a method for transmitting the collision impact load F to the lower pillar reinforcement 3A.

In contrast, if the door impact beam attachment member 11 is attached at a position where the door impact beam attachment member 11 does not overlap with the lower hinge 4 in the vehicle side view, a collision impact load F transmitted to the door impact beam attachment member 11 from the door impact beam 10 is transmitted to the lower pillar reinforcement 3A without the lower hinge 4 being intervened. Accordingly, it is possible to control the method for transmitting the collision impact load F to the lower pillar reinforcement 3A.

In the vehicle side view, the attachment position of the door impact beam attachment member 11 with respect to the rear door is located across the lower fragile portion 8.

As described above, in the door impact beam attachment member 11, the pair of connection portions 11b are disposed at the inside farther than the retention portion 11a. For this reason, the pair of connection portions 11b of the door impact beam attachment member 11 become portions that transmit the collision impact load F to the lower pillar reinforcement 3A. Accordingly, in the lower pillar reinforcement 3A, the pair of connection portions 11b are pressed where a force application point f of the collision impact load F is located. At this time, if the force application point f of the collision impact load F can be disposed across the lower fragile portion 8, it is possible to concentrate the collision impact load F on the lower fragile portion 8.

Herein, in one of the following three modes, in the vehicle side view, the door impact beam attachment member 11 crosses the lower fragile portion 8. A first mode is a mode in which the pair of connection portions 11b crosses the lower fragile portion 8. A second mode is a mode in which the upper connection portion 11b covers the lower fragile portion 8. A third mode is a mode in which the lower connection portion 11b covers the lower fragile portion 8.

In the first mode, both of the upper and the lower connection portions 11b are pressed against an upper side of the lower fragile portion 8 due to the collision impact load F. For this reason, in the first mode, the force application point f of the collision impact load F is disposed across the lower fragile portion 8.

In the second mode, the upper connection portion 11b is pressed against both of the upper side and a lower side of the lower fragile portion 8 due to the collision impact load F. For this reason, in the second mode, the force application point f of the collision impact load F is disposed across the lower fragile portion 8.

In the third mode, the lower connection portion 11b is pressed against both of the upper and the lower sides of the lower fragile portion 8 due to the collision impact load F. For this reason, in the third mode, the force application point f of the collision impact load F is disposed across the lower fragile portion 8.

As such, even in any one of the modes, the force application point f of the collision impact load F can be disposed across the lower fragile portion 8. For this reason, in the vehicle side view, it is possible to concentrate the collision impact load F on the lower fragile portion 8 by attaching the door impact beam attachment member 11 across the lower fragile portion 8.

At this time, in the second and the third modes, it is possible to bring the force application point f close to the lower fragile portion 8 and thus, it is possible to further concentrate the collision impact load F on the lower fragile portion 8.

In the vehicle side view, the attachment position of the door impact beam attachment member 11 with respect to the rear door does not overlap with the position of the upper fragile portion 7.

As such, in the vehicle side view, since the door impact beam attachment member 11 and the upper fragile portion 7 do not overlap each other, it is possible to prevent the force application point f of the collision impact load F from being located across the upper fragile portion 7. Accordingly, it is possible to reduce the collision impact load F transmitted to the upper fragile portion 7.

At this time, if the attachment position of the door impact beam attachment member 11 is located as per the second mode, it is possible to greatly keep the force application point f away from the upper fragile portion 7. For this reason, it is possible to further reduce the collision impact load F transmitted to the upper fragile portion 7.

The aforementioned attachment positions of the door impact beam attachment member 11 refer to positions in a state where the rear door is closed. For this reason, as a matter of course, when the rear door is opened, the door impact beam attachment member 11 and the pillar reinforcement 3 have a changed position relationship.

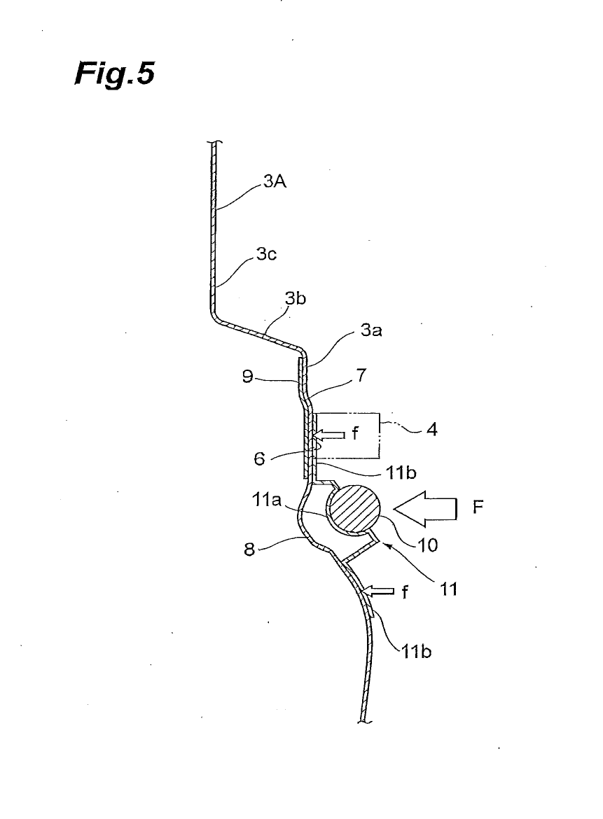

Subsequently, when another vehicle collides with a rear door of a host vehicle, an operation of the center pillar structure 1 will be described with reference to FIGS. 4 and 5. FIG. 5 is a partial end surface view illustrating a state where the collision impact load F is applied to the lower pillar reinforcement from the door impact beam.

As illustrated in FIG. 4, before the other vehicle collides with the rear door of the host vehicle, the door impact beam attachment member 11 is retained at position that separates from the position of the lower pillar reinforcement 3A.

As illustrated in FIG. 5, when the other vehicle collides with the rear door of the host vehicle, the door impact beam 10 and the door impact beam attachment member 11 are pressed inward due to the collision impact load F. Accordingly, the pair of connection portions l 1b of the door impact beam attachment member 11 are pressed against the lower pillar reinforcement 3A without the lower hinge 4 being intervened.

Since the force application point f of the collision impact load F crosses the lower fragile portion 8, the collision impact load F concentrates on the lower fragile portion 8. At this time, since the force application point f of the collision impact load F does not cross the upper fragile portion 7, a small amount of the collision impact load F is transmitted to the upper fragile portion 7. In addition, the upper fragile portion 7 is reinforced with the hinge reinforcement 9 and thus, the upper fragile portion is unlikely to bend. The lower fragile portion 8 has strength lower than that of the upper fragile portion 7.

As such, since the lower fragile portion 8 is likely to bend in preference to the upper fragile portion 7, only the lower fragile portion 8 of the lower pillar reinforcement 3A bends due to the collision impact load F. In a case where the collision impact load F has a magnitude that cannot be absorbed by only the lower fragile portion 8, the lower fragile portion 8 bends and then the upper fragile portion 7 bends.

Since only the lower fragile portion 8 bends, or the lower fragile portion 8 bends in preference to the upper fragile portion 7, the amount of deformation of a lower portion of the lower pillar reinforcement 3A becomes large, and an upper portion of the lower pillar reinforcement 3A and the upper pillar reinforcement 3B are prevented from having a large amount of deformation.

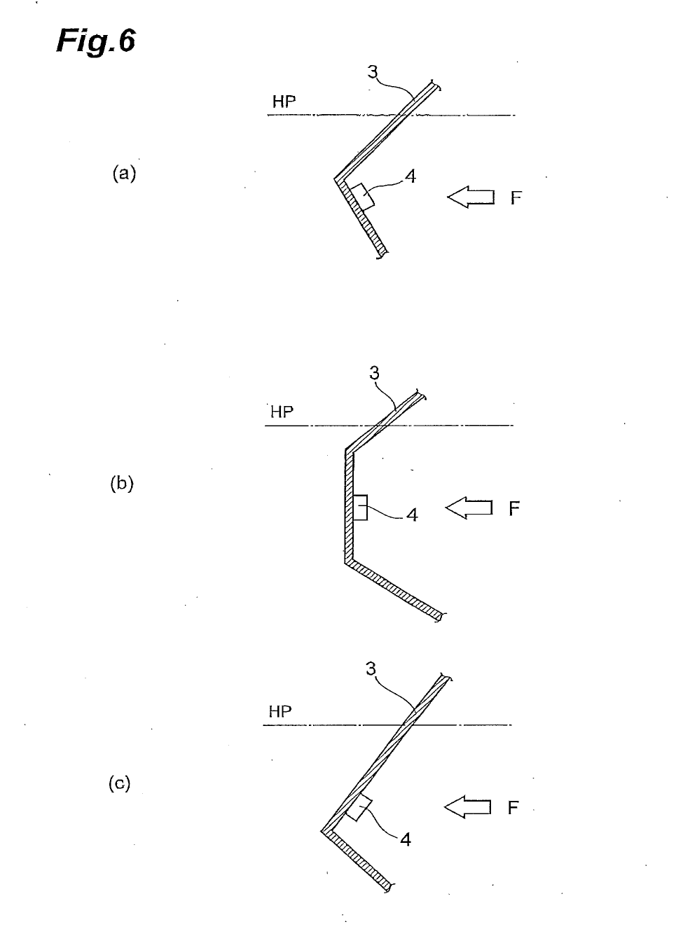

Herein, bending modes of the pillar reinforcement 3 will be described with reference to table 1 and FIG. 6. Table 1 illustrates the bending modes of the pillar reinforcement. FIG. 6 conceptually illustrates the bending modes of the pillar reinforcement. FIG. 6(a) is a view conceptually illustrating a first mode, FIG. 6(b) is a view conceptually illustrating a second mode, and FIG. 6(c) is a view conceptually illustrating a third mode. In FIGS. 6(a) to 6(c), a right side indicates the outside of the vehicle, and a left side indicates the inside (vehicle interior) of the vehicle. In FIGS. 6(a) to 6(c), a hip point (HP) indicates a height at which an occupant is positioned, and in detail, indicates a height around the occupant's waist part when the occupant sits on a seat.

TABLE 1

| | existence or non-existence | | the amount of |
|---|---|---|---|
| | of bending | | deformation of |
| mode | above hinge | below hinge | occupant's height |
| 1 | existence | non-existence | large |
| 2 | existence | existence | medium |
| 3 | non-existence | existence | small |

As illustrated in Table 1 and FIG. 6, there are the following three bending modes of the pillar reinforcement. That is, the first mode is a mode in which only a portion above the lower hinge 4 bends. The second mode is a mode in which both portions above and below the lower hinge 4 bend. The third mode is a mode in which only a portion below the lower hinge 4 bends.

In the first mode, since only the portion above the lower hinge 4 bends, the amount of deformation of the pillar reinforcement 3 becomes large at the occupant's height HP.

In the third mode, since only the portion below the lower hinge 4 bends, the amount of deformation of the pillar reinforcement 3 becomes small at the occupant's height HP.

In the second mode, since both of the portions above and below the lower hinge 4 bend, the amount of deformation of the pillar reinforcement 3 at the occupant's height HP becomes medium between the first mode and the third mode.

In the center pillar structure 1 according to the embodiment, it is possible to stably set the bending mode of the pillar reinforcement 3 to the third mode and thus, it is possible to stably reduce the amount of deformation of the pillar reinforcement 3 at the occupant's height HP.

As described above, according to the center pillar structure 1 according to the embodiment, when the collision impact load F is transmitted to the pillar reinforcement 3 from the door impact beam attachment member 11, deformation of the lower fragile portion 8 is promoted, deformation of the upper fragile portion 7 is suppressed and thus, it is possible to stably control the bending mode of the pillar reinforcement 3. For this reason, when the collision impact load F is applied to the pillar, it is possible to reliably bend the lower fragile portion 8 in preference to the upper fragile portion 7. It is possible to stably reduce the amount of deformation of the pillar reinforcement 3 at the occupant's height HP. Accordingly, it is possible to improve robustness against a side impact collision.

Since the lower fragile portion 8 has strength lower than that of the upper fragile portion 7, and only the upper fragile portion 7 is reinforced with the hinge reinforcement 9, when the collision impact load F is transmitted to the pillar reinforcement 3 from the door impact beam attachment member 11, it is possible to further promote deformation of the lower fragile portion 8.

The preferred embodiment of the present invention is described above, but the present invention is not limited to the embodiment.

For example, the embodiment describes a case where the bending mode of the pillar reinforcement 3 is set to the third mode, but depending on vehicle design philosophy, the bending mode of the pillar reinforcement 3 may be set to either the first mode or the second mode. In the first mode, in the vehicle side view, the attachment position of the door impact beam attachment member 11 is set to locate across the upper fragile portion 7, the lower fragile portion 8 is set to be reinforced with the hinge reinforcement 9, and the upper fragile portion 7 is set to have strength lower than that of the lower fragile portion 8. In the second mode, in the vehicle side view, the attachment position of the door impact beam attachment member 11 is set to locate across the lower fragile portion 8 and the upper fragile portion 7, the lower fragile portion 8 and the upper fragile portion 7 are not set to be reinforced with the hinge reinforcement 9, and the lower fragile portion 8 and the upper fragile portion 7 are set to have the same strength.

The embodiment describes a case where the lower fragile portion 8 has strength lower than that of the upper fragile portion 7, but the lower fragile portion 8 and the upper fragile portion 7 may have the same strength.

The embodiment describes a case where the hinge reinforcement 9 is used as a reinforcement member with which the upper fragile portion 7 is reinforced, but other members may be used, and a new reinforcement member may be used.

The embodiment describes the center pillar structure but, the present invention may be applicable to other pillar structures.

### INDUSTRIAL APPLICABILITY

The present invention is applicable to the pillar structure for a vehicle, to which the hinge of the door is attached.

### REFERENCE SIGNS LIST

1 center pillar structure (pillar structure)

2 center pillar

3 pillar reinforcement

3A lower pillar reinforcement

3B upper pillar reinforcement

3a outer surface

3b side surface portion

3c flange portion

4 lower hinge (hinge)

5 upper hinge

6 lower hinge attachment portion

7 upper fragile portion (the other fragile portion)

8 lower fragile portion (one fragile portion)

9 hinge reinforcement (reinforcement member)

10 door impact beam

11 door impact beam attachment member

11a retention portion

11b connection portion

F impact load (external load)

f force application point

L laser welding partition line

1. A pillar structure for a vehicle, to which a hinge of a door is attached,
wherein a fragile portion is formed, respectively, above and below an attachment position of the hinge,
wherein a force application member is disposed in one fragile portion of the fragile portions to transmit an external load to the fragile portions via across the one fragile portion, and
wherein a reinforcement member is disposed in the other fragile portion of the fragile portions to suppress deformation of the other fragile portion, and
wherein the reinforcement member is in close contact with an inside of the other fragile portion.

2. The pillar structure for a vehicle according to claim 1,
wherein the one fragile portion is disposed below the other fragile portion.

3. The pillar structure for a vehicle according to claim 1,
wherein the one fragile portion has strength lower than that of the other fragile portion.

4. The pillar structure for a vehicle according to claim 1,
wherein the force application member is a door impact beam attachment member that attaches a door impact beam to the door.

5. The pillar structure for a vehicle according to claim 1,
wherein the reinforcement member is a hinge reinforcement that is disposed to face the hinge with respect to a pillar.
